(19) United States
(12) Patent Application Publication
(10) Pub. No.: US 2016/0214902 A1
(43) Pub. Date: Jul. 28, 2016

(54) Piezoelectric-effect-induced heterogeneous electrochemical reactions

(71) Applicant: Sandia Corporation, Albuquerque, NM (US)

(72) Inventors: Haiqing L. Schwarz, Albuquerque, MN (US); David Scrymgeour, Albuquerque, NM (US)

(21) Appl. No.: 15/002,231

(22) Filed: Jan. 20, 2016

Related U.S. Application Data
(60) Provisional application No. 62/108,623, filed on Jan. 28, 2015.

(51) Int. Cl. C04B 35/472; C04B 35/468; C04B 35/622

(52) U.S. Cl. CPC C04B 35/472; C04B 35/62259; C04B 35/4682

(57) ABSTRACT

Domain polarization can affect the surface properties of ferroelectric oxides. Mechanical energy is exploited to enable direct chemical reactions on the ferroelectric surface by the piezoelectric effect. Transient local electrostatic potentials on ferroelectric surface evoked by external mechanical excitation through the piezoelectric effect can activate redox reactions in solution at predefined domain locations. Conversion of mechanical via electrical to chemical energy can thereby be realized.

### CROSS-REFERENCE TO RELATED APPLICATION

This application claims the benefit of U.S. Provisional Application No. 62/108,623, filed Jan. 28, 2015, which is incorporated herein by reference.

### STATEMENT OF GOVERNMENT INTEREST

This invention was made with Government support under contract no. DE-AC04-94AL85000 awarded by the U. S. Department of Energy to Sandia Corporation. The Government has certain rights in the invention.

### FIELD OF THE INVENTION

The present invention relates to electrochemical reactions and, in particular, to piezoelectric-effect-induced heterogeneous electrochemical reactions in solution.

### BACKGROUND OF THE INVENTION

Ferroelectrics are functional materials whose physical properties are sensitive to changes in external conditions like electric field (ferroelectricity), stress (piezoelectricity), and change of temperature (pyroelectricity). The piezoelectric properties make ferroelectrics ideal for use in actuators and sensors due to their mechanical and electrical coupling, as well as manipulation of charge-carrier conduction in semiconductor heterostructures (i.e. piezotronics). See X. Wang et al., Nano Letters 6(12), 2768 (2006); and Z. L. Wang, Advanced Materials 19(6), 889 (2007). The photochemical properties of the ferroelectrics utilize local domain polarizations to influence the surface chemical reactivity, which has led to important technological applications such as ferroelectric lithography and the assembly of complex nanostructures. See J. L. Giocondi and G. S. Rohrer, Journal of Physical Chemistry B 105(35), 8275 (2001); D. Li and D. A. Bonnell, Ceramics International 34(1), 157 (2008); S. V. Kalinin et al., Nano Letters 2(6), 589 (2002); and J. L. Giocondi and G. S. Rohrer, Chemistry of Materials 13(2), 241 (2001). However, coupling mechanical energy with chemical energy via the piezoelectric effect for surface chemical reactions on ferroelectric surface has been an overlooked research area with limited exploitation, lacking a mechanism linking the ferroelectric structures on the nanoscale with the chemical reactions. See K.-S. Hong et al., The Journal of Physical Chemistry Letters 1(6), 997 (2010); K.-S. Hong et al., The Journal of Physical Chemistry C 116(24), 13045 (2012); and M. B. Starr et al., Angewandte Chemie International Edition 51(24), 5962 (2012).

### SUMMARY OF THE INVENTION

The invention is directed to an electrospinning and sol-gel process combined with proper heat treatment to synthesize highly crystalline ferroelectric nanofibers. The invention is further directed to piezoelectric-effect-induced electrochemical reactions wherein the ferroelectric domain structures of nanostructures enable surface chemical reactions through a piezoelectric effect. Transient local electrostatic potentials on a ferroelectric surface developed by external mechanical excitation, when large enough, can be used to activate redox reactions in solution. As an example of the invention, heterogeneous piezoelectric-effect-induced chemical reactions confirmed the mechanical via electrical to chemical energy conversion on ferroelectric barium titanate (BaTiO₃) nanofibers. The BaTiO₃ nanofibers do not require poling because heterogeneous chemical reactions occur on the randomly distributed charged surfaces.

Polarization enabled surface chemistry directly impacts soft-matter manipulation at a liquid-solid interface. Piezoelectric-effect-induced chemical reactions in fluidics provide a new interface for adsorption, catalysis, and electrochemistry. This may enable revolutionary use of ferroelectric materials via interfacial engineering by its piezoelectric properties, which includes applications in degradation of organics (biofouling self-cleaning), molecular sensing, catalysis, and surface wettability, etc. Particularly at locations where light is unavailable, this technology can complement photochemical catalysis. Finally, nano-based ferroelectric materials can be developed as a new generation of energy harvesting components.

### BRIEF DESCRIPTION OF THE DRAWINGS

The detailed description will refer to the following drawings, wherein like elements are referred to by like numbers.

FIGS. 1(a)-(c) show domain orientations and electrical potentials in a model system of BaTiO₃ with domain orientations intersecting a (100) surface.

FIG. 2 is a schematic illustration of a mechanism of piezoelectric-effect induced surface chemistry. The simplified schematic suggests that a transient imbalance between induced polarization and screening charges can provide needed local electrostatic potential to initiate surface redox reactions.

FIGS. 3(a) and 3(b) illustrate a method for combining electrospinning and sol-gel chemistry to produce BaTiO₃ nanofibers.

FIGS. 4(a)-(c) illustrate piezoelectric force microscopy (PFM) showing piezoresponse to a driving voltage.

FIGS. 5(a)-(c) illustrate sample preparation for nanofiber imaging using PFM.

FIGS. 6(a) and 6(b) are images of as spun BaTiO₃ nanofibers before heat treatment. The as-synthesized BaTiO₃ nanofiber membrane is shown in an optical micrograph in FIG. 6(a) and a scanning electron micrograph (SEM) in FIG. 6(b).

FIG. 7 is a graph of thermogravimetric analysis (TGA) of BaTiO₃ nanofibers.

FIGS. 8(a)-(f) show SEMs of the evolving nanocrystal structures of BaTiO₃. With an alkoxide-carboxylate precursor concentration of 0.5 M, SEMs of nanocrystalline structures of BaTiO₃ nanofibers are shown under different thermal treatment temperatures at 600° C., 750° C., 850° C., 950° C., and 1100° C. 10 hour, and 1100° C. 12 hour, respectively.

FIG. 9 is an HR-TEM of a typical BaTiO₃ crystal within the fiber. The inset is the FFT of the lattice fringes and reveals the 100 plane of BaTiO₃.

FIG. 10 is an HR-TEM of adjacent crystals in BaTiO₃ nanofibers.

FIGS. 11(a)-(d) are SEMs illustrating the structure and morphology of the BaTiO₃ fibers at 0.2M, 0.3M, 0.5M, and 0.75M precursor concentrations, respectively.

FIG. 12 is a graph of x-ray diffraction (XRD) patterns showing outstanding crystallinity of the BaTiO₃ nanofiber.

FIG. 13 is a graph of XRDs of BaTiO₃ nanofibers after thermal treatment at 600° C., 750° C., 850° C., 950° C., and 1100° C.

FIG. 14 is a graph of XRDs of BaTiO₃ nanofibers prepared at 0.2M, 0.3M, 0.5M, and 0.75M precursor concentrations.

FIGS. 15(a) and 15(b) Raman spectra of BaTiO₃ nanofiber materials prepared at 0.5M precursor concentration and thermal treatment at 950° C. and 1100° C. for 10 h. FIG. 15(a) shows the narrow Raman peak at 720 cm⁻¹ is specific to the tetragonal phase of BaTiO₃ for the nanofibers prepared at 1100° C. FIG. 15(a) shows the normalized difference spectrum suggesting the tetragonal phase of BaTiO₃.

FIGS. 16(a)-(c) are contact mode images of a long continuous BaTiO₃ fiber embedded in photoresist showing topography, piezoresponse amplitude, and piezoelectric phase, respectively.

FIGS. 17(a)-(c) are SEM images of the Ag nanoparticle formation on BaTiO₃ fibers. FIGS. 17(a) and 17(b) are SEMs showing representative areas on BaTiO₃ fibers with predefined patterns of Ag nanoparticle deposition. FIG. 17(c) is an SEM of the TiO₂ fiber control. FIG. 17(d) is an EDX of the Ag—BaTiO₃ sample.

FIG. 18(a) is an HR-TEM of BaTiO₃ nanocrystal and the Ag nanoparticle deposited on it. FIG. 18(b) is a nanoprobe EDX indicating the Ag presence.

FIGS. 19(a) and 19(b) are HR-TEMs showing larger Ag particles grown in certain regions, particularly at the grain boundaries.

FIGS. 20(a)-(c) are SEMs of Ag particle deposition on BaTiO3 nanofibers from different concentrations of AgNO₃ solutions: 0.01 M, 0.05 M, 0.5 M, respectively.

### DETAILED DESCRIPTION OF THE INVENTION

The present invention uses transient electrostatic potentials, most likely generated by a transient imbalance between induced polarization and screening charges when mechanically exciting ferroelectric materials in solution, to induce heterogeneous electrochemical reactions. In theory, based on the piezoelectric effect, an instantaneous local electrostatic potential evoked by external mechanical excitation, if large enough, will provide the needed energy to activate redox reactions locally on the surface. The induced polarization of the ferroelectrics under mechanical excitation can have a strong influence on the surface charges, which can then be used to drive heterogeneous surface chemical reactions.

Perovskite ferroelectric oxides, such as BaTiO₃, contain internal electric dipoles that are intrinsic to the atomic structure of the compound. The displacement or distortion of the body-center cation (Ti in the case of BaTiO₃) in the unit cell produces a dipole in the structure, stretching the cubic lattice along one of its lattice vectors to a tetragonal lattice. In other words, anything that distorts the lattice will change the strength of the dipoles, therefore changing the spontaneous polarization. The change in the spontaneous polarization results in a change in the surface charge. The resulting electric dipole is ultimately responsible for the property of ferroelectricity because the dipole-dipole interactions between unit cells cause polarization alignment resulting in ferroelectric domains. Other piezoelectric and perovskite ferroelectric materials, such as Pb(Zr,Ti)O₃ (PZT), PbTiO₃, and (Ba,Sr)TiO₃ (BST), exhibit similar properties and can be used with the present invention.

In order to realize a piezoelectric-effect-induced chemical reaction, a piezoelectric response is an essential requirement. Ferroelectricity is not required. However, it just happens that the piezoelectric materials with the highest performance and, therefore, the greatest amount of charge per mechanical input are traditionally ferroelectric materials, such as BaTiO₃. Accordingly, ferroelectric (which is also piezoelectric) BaTiO₃ nanofibers are described below as an example of the invention.

### Domain Polarizations and Surface Properties

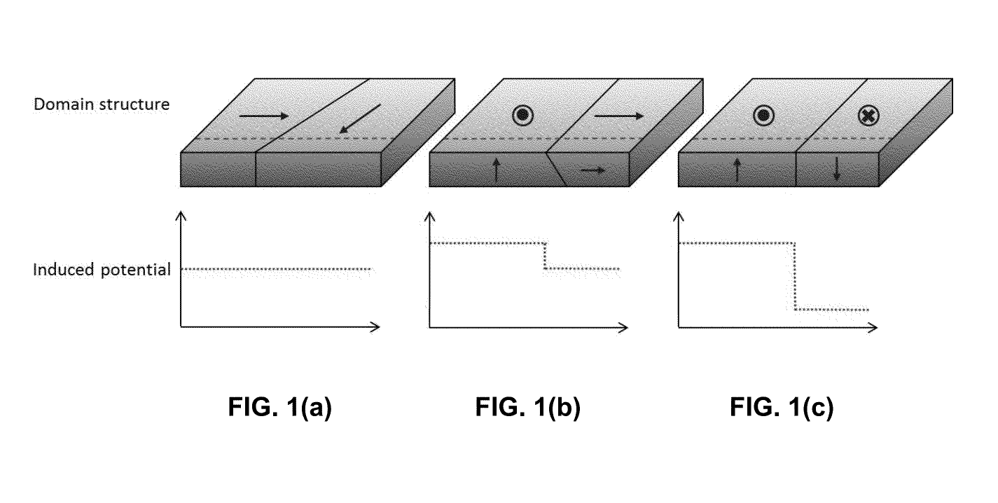

In ferroelectrics, spontaneous polarization discontinuities in the vicinity of surfaces and interfaces lead to polarization bound charges. Such domain polarizations result in large surface charges on the domain termination, although they are always screened either by internal compensation (free charges inside crystals) or external compensation (adsorption of counter ions). Therefore, domain polarization can largely affect the surface properties of ferroelectric oxides, which lead to domain specific phenomena. The relationship between domain polarization orientation and surface potential is illustrated in FIGS. 1(a)-(c). Domains oriented with polarizations aligned perpendicular to the surface in the positive or negative direction will induce a surface potential. Therefore, in domain regions with positive polarization, the effective surface charge becomes more positive, as shown in FIG. 1(b), whereas in regions with negative polarization, the surface charge becomes more negative, as shown in FIG. 1(c). See D. Li and D. A. Bonnell, Ceramics International 34(1), 157 (2008); and S. V. Kalinin et al., Nano Letters 2(6), 589 (2002).

Photochemistry (photocatalysis) is a well-known example that utilizes ferroelectric domain polarizations to induce direct chemical reactions on ferroelectric surfaces. See J. L. Giocondi and G. S. Rohrer, Journal of Physical Chemistry B 105(35), 8275 (2001); J. L. Giocondi and G. S. Rohrer, Chemistry of Materials 13(2), 241 (2001); J. L. Giocondia and G. S. Rohrer, MRS Proceedings 654, AA7.4.1 (2000); and R. G. Li et al., Nat. Commun. 4 (2013). In the case of photocatalysis on ferroelectrics, photo-excited electron-hole pairs are driven by the space charge region due to internal dipole orientations and move to the opposite domains near the surface to create the surface charges which consequently enable chemical reactions. The exact location of such chemical reactions is defined by the presence of photo-generated carriers on the ferroelectric surface, which is directly related to the local polarization states; therefore it is a domain specific phenomenon.

Other types of energy sources, such as mechanical energy by piezoelectric effect, or temperature change by pyroelectric effect, theoretically can realize the energy conversion needed to enable chemical reactions on the ferroelectric surface in aqueous environments. However, these research areas have been underrepresented. There is not a true heterogeneous chemical reaction system relating to domain polarization dynamics based on the piezoelectric effect of ferroelectrics reported in the open literature. See K.-S. Hong et al., The Journal of Physical Chemistry Letters 1(6), 997 (2010); and E. Gutmann et al., Journal of Physical Chemistry C 116(9), 5383 (2012).

### Mechanism for Piezoelectric-Effect-Induced Redox Reactions

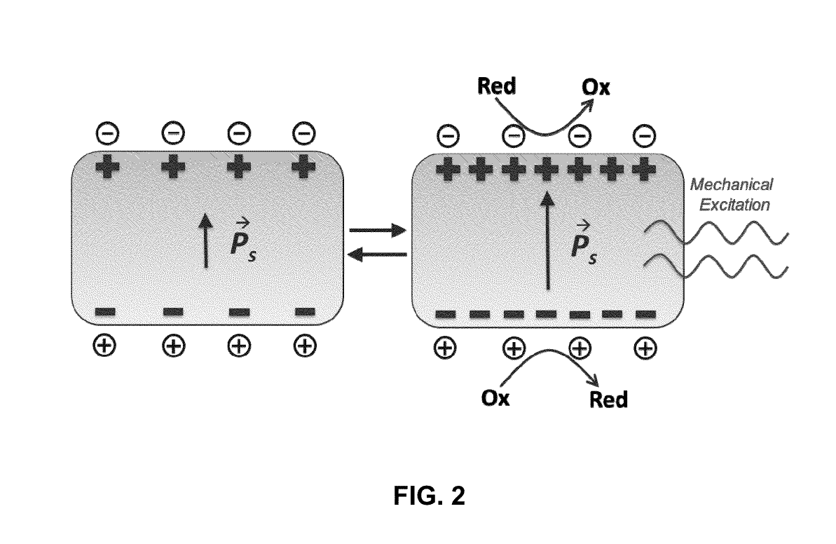

Analogous to photochemical catalysis, a redox chemical reaction induced by the piezoelectric effect on a ferroelectric surface can be domain specific. Through the piezoelectric effect, local electrostatic fields generated by external mechanical excitation can be useful to activate a surface chemistry. This piezochemical mechanism is illustrated schematically in FIG. 2. The piezoelectric response to a transient mechanical excitation causes a transient imbalance between induced polarization and screening charges (a time when the induced polarization has not been compensated yet by screening charges). The resulting instantaneous electrostatic potential, if large enough, can provide the energy to initiate electrochemical reactions on the ferroelectric surface in predefined domain locations. The local chemical reactivity can be correlated to the local polarization fields. This mechanism can enable heterogeneous piezochemical reactions on ferroelectric surfaces when sufficient mechanical energy is supplied.

### Electrospun Ferroelectric Nanofibers

Electrospun nanofibers were prepared as an exemplary ferroelectric material because they have excessively large reactive surface areas. For any heterogeneous chemical reaction, high surface areas are beneficial. The surface-to-volume ratio for a structure with a characteristic dimension of 1 m is 1 m⁻¹, whereas that for a micro/nano structure having a size of 1 μm is 10⁶ m⁻¹. Further, since the polarization state of the surface in ferroelectric materials is domain dependent, nanoscale fibers possessing very large surface areas can make patterns of such non-Faradaic surface charge fully accessible. Compared to bulk materials, nanofibers have unique benefits, including high surface area and free-standing structures to maintain material integrity. However, other high surface area micro/nanostructures having characteristic dimensions of order microns or less can also be used with the invention, such as nanoparticles, nanorods, nanowires, and nanosheets.

Due to large surface area per unit volume typical of micro/nanostructures, the ionic screening effect is expected to be less effective, consequently chemical reactivity at the interface can be expected to be enhanced compared to their bulk counterpart. For example, for barium titanate (BaTiO₃), the spontaneous polarization Pₛ is 0.15 C/m². The surface charge of a fabricated beam with a size of 24 mm×4 mm×0.25 mm can be calculated to be 30 μC, thus complete compensation of this charge quantity is equal to 3×10⁻¹⁰ mol of electrolyte materials, with equivalent of 0.3 mL (1 μM). See D. Li and D. A. Bonnell, Ceramics International 34(1), 157 (2008). When increasing the surface area for nanofibers with average size of 50 nm×5 μm, the overall surface charge is 0.3 C, which means it requires 10⁴ times more (3 L) electrolyte to screen the surface charge. In other words, transient imbalance between induced polarization and screening charges will be easier to reach under a definite solution concentration for ferroelectrics with large surface area. This comparison suggests that bulk geometry will be much less effective in utilizing induced surface charge for powering chemical reactivity than micro/nanostructures, such as the nanofibers.

### Synthesis of Ferroelectric BaTiO₃ Nanofibers

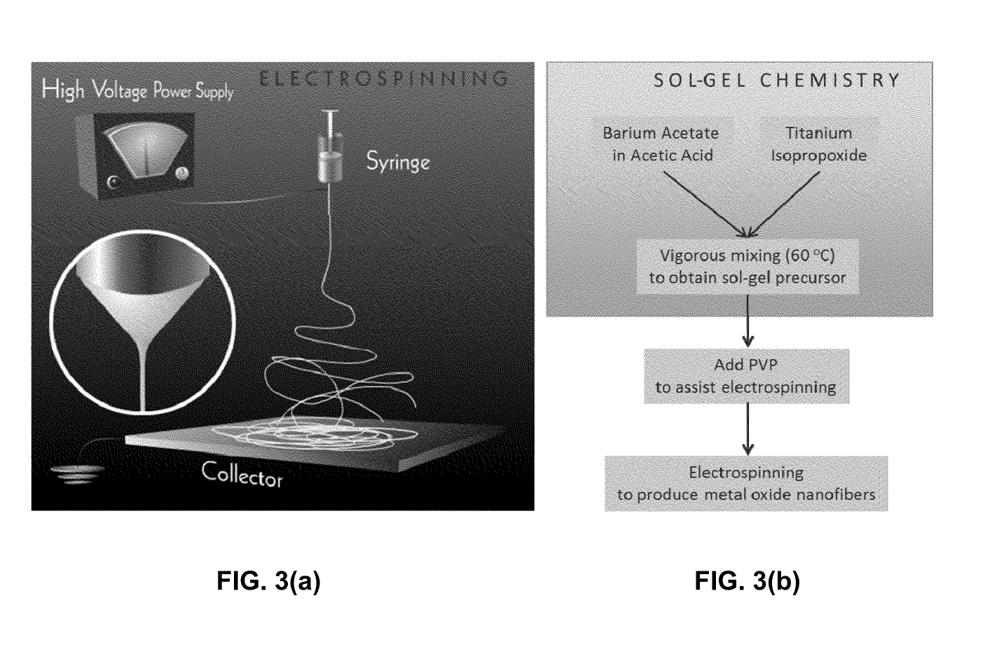

Electrospinning and sol-gel chemistry were used to fabricate exemplary BaTiO₃ nanofiber precursors, as illustrated in FIGS. 3(a) and 3(b). The preparation of nanocrystalline ferroelectric BaTiO₃ nanofibers involves electrospinning and sol-gel of alkoxide-carboxylate synthesis processes. As shown in FIG. 3(a), an electrospinning apparatus comprises a spinneret, typically a hypodermic syringe needle, connected to a high-voltage direct current power supply, a syringe pump, and a grounded collector. A sol-gel mixture is loaded into the syringe and this liquid is extruded from the needle tip at a constant rate by a syringe pump. An electric force draws charged threads of the mixture up to fiber diameters of order ten nanometers. As shown in FIG. 3(b), the alkoxide-carboxylate precursor for BaTiO₃ comprises titanium isopropoxide and barium acetate. With acetic acid as the only solvent in the system and appropriate dissolving strategy, a minimal amount of matrix polymer (polyvinylpyrrolidone, PVP), ca. 2%, can be used to achieve the proper electrospinning viscosity. Adding PVP significantly increases the ceramic fiber yield and improves the ceramic fiber quality while minimizing interference for sol-gel chemistry. Other water-soluble polymers can also be used as the matrix polymer, such as polyethylene oxide (PEO) and polyvinyl alcohol (PVA). The sol-gel precursor hydrolyzes and condenses to generate an inorganic gel network as the compound jet is electrospun into air, setting the fiber morphology. To achieve high piezoelectric properties, many factors should be taken into account; however post-spinning thermal treatment is likely a most important variable. The post-spinning thermal treatment can include the following steps: 1) heating to 120° C. for 1 hr to remove solvent and allow hydrolysis and condensation to complete in air; 2) heating to 600° C. for 3 hr to burn off polymer components and enable perovskite phase crystallization onset; and 3) heating to 1100° C. for 10 hr to further decompose barium carbonate and enable full crystallization of perovskite barium titanate.

### Piezoresponse Force Microscopy Characterization

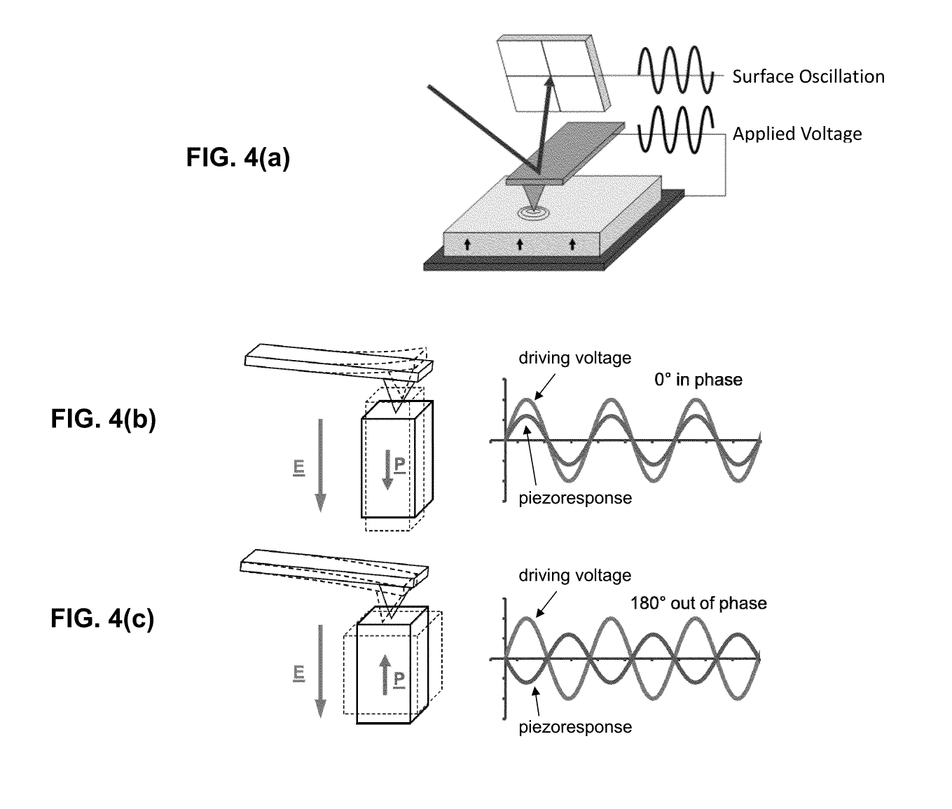

Piezoresponse force microscopy (PFM) is a powerful tool widely used for nanoscale studies of the electromechanical coupling effect. PFM is a contact scanning probe technique using the converse piezoelectric effect where small distortions of the sample surface induced by an oscillating (ac) voltage applied with a conductive tip are imaged. See K. Franke and M. Weihnacht, Ferroelectrics Letters Section 19(1-2), 25 (1995); A. Gruverman et al., Annu. Rev. Mater. Sci. 28, 101 (1998); M. Alexe and A. Gruverman, Nanoscale Characterisation of Ferroelectric Materials, Springer (2004). This allows for the simultaneous acquisition of the topography and the amplitude and phase of the piezoelectric signal with respect to the applied voltage. As shown schematically in FIGS. 4(a)-(c), PFM is based on the detection of local piezoelectric deformation of a ferroelectric sample induced by an external electric field. Depending on the relative orientations of the applied field and the polarization vector, sample deformation can be in the form of elongation, contraction, or shear. Thus, opposite domains can be visualized by monitoring their voltage-induced surface displacement. For example, as shown in FIG. 4(b), application of a uniform electric field along the polar direction results in the elongation of the domain with polarization parallel to the applied field and in the contraction of the domain with opposite polarization. By employing a dynamic piezoresponse imaging method, an ac voltage modulation is applied to the ferroelectric sample and surface displacement is measured by detecting the vertical vibration of a cantilever, which follows the sample surface oscillation, using a standard lock-in technique. A domain map can be obtained by scanning the surface while detecting the first harmonic component of the normal surface vibration. The phase difference between the imaging voltage and piezoresponse provides information on the polarization direction. With the modulation voltage applied to the probing tip, positive domains (polarization vector oriented downward) will vibrate in phase with the applied voltage, as shown in FIG. 4(b), while vibration of negative domains (polarization vector oriented upward) will occur in counter phase, as shown in FIG. 4(c).

PFM was performed on the electrospun ferroelectric nanofibers using an atomic force microscope (AFM) with Ti—Pt coated tips with a nominal tip radius of 50 nm. For the PFM imaging, the photodiode sensor response was accessed by a signal access module and input into an external lock-in amplifier. Typical PFM imaging conditions used a tip bias of 5 Vᵣₘₛ voltage at a frequency of ˜15 kHz supplied by an external function generator. Calibration of the PFM was done through calibration of the photodiode response by force distance curves taken with individual tips. See M. Alexe and A. Gruverman, Nanoscale Characterisation of Ferroelectric Materials, Springer (2004). The raw lock-in output (Vᵣₘₛ) was converted into a calibrated piezoelectric amplitude (pm/V) value using the photodiode sensitivity calculated from the force distance curve (nm/V), the lock-in sensitivity (mV/V), and the applied voltage (V). The frequency dependence and low level background noise was removed following a background correction procedure. See T. Jungk et al., Appl. Phys. Lett. 89, 163507 (2006). This was determined by scanning a piece of periodically poled LiNbO₃ sample to determine the background signal at a specific frequency for a given tip. This value was then subtracted from subsequently measured values.

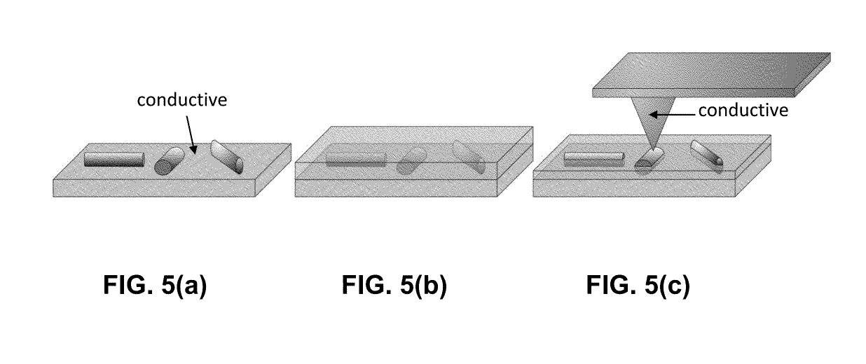

To image the BaTiO₃ nanofibers, the fibers were first drop cast from ethanol onto a Pt-coated silicon wafer, as shown in FIG. 5(a). In contact mode images, the fibers were too mechanically fragile and were easily broken by the AFM tip and easily dislodged from the sample surface. Therefore, to provide a mechanically robust imaging situation for contact mode, the drop cast fibers were embedded in photoresist by spin coating, as shown in FIG. 5(b), and then etched with Ar—O₂ plasma to expose the surface of the fibers for PFM imaging, as shown in FIG. 5(c).

### Piezoelectric-Effect Driven Redox Reactions in Solutions

To investigate the piezoelectric-effect-induced electrochemical reactions in aqueous solutions, silver nanoparticle reduction from silver nitrate solutions was used as an exemplary redox reaction. Silver nitrate (AgNO₃) was dissolved in double distilled water to desired concentrations. The BaTiO₃ nanofiber membranes were immersed in AgNO₃ solution contained in a polyethylene storage bag, which was subsequently immersed in an ultrasonic water bath, operated at 20 kHz frequency, at desired power levels (˜250 Watts). Silver reduction from aqueous solutions of 0.01 M, 0.05 M, and 0.5 M silver nitrate onto the BaTiO₃ nanofiber surfaces was investigated. The size and distribution of Ag nanoparticle deposition on BaTiO₃ nanofibers were determined from SEM and HR-TEM characterization, and elemental analysis was determined from EDX spectra. TiO₂ nanofibers were used as a control material to conduct the same experiments in parallel.

Silver particles were deposited on BaTiO₃ nanofiber surface dissolved in 1 M nitric acid to obtain [Ag⁺] concentration. The corresponding [Ag⁺] of the sample was measured using an electrochemistry method, which showed a marked difference. In a positive control experiment, the BaTiO₃ nanofibers were prepared in AgNO₃ solution, followed by irradiating the sample with an ultraviolet (UV) source at 250 W for 1 hour. The UV light source was 302 nm light from a 250 W quartz-halogen lamp. In a negative control, the BaTiO₃ nanofibers were immersed in boiling AgNO₃ solutions for 1 hour.

### Structural and Morphological Characterization of BaTiO₃ Fibers

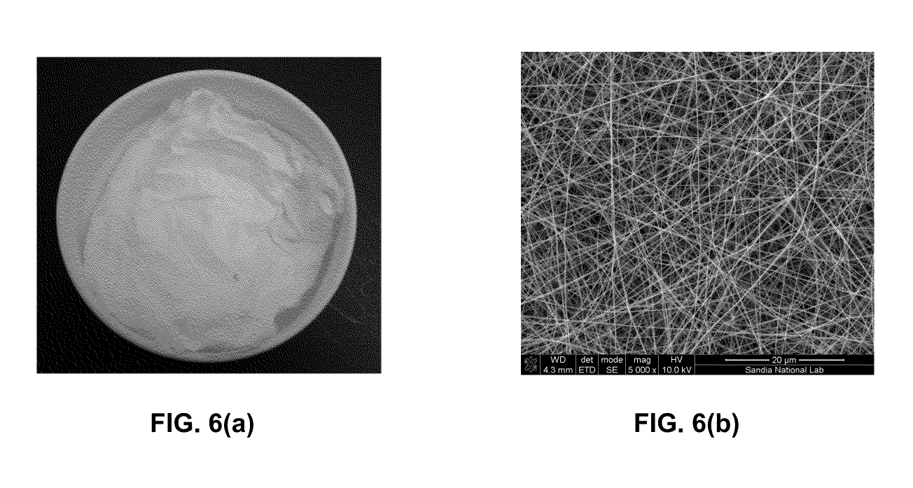

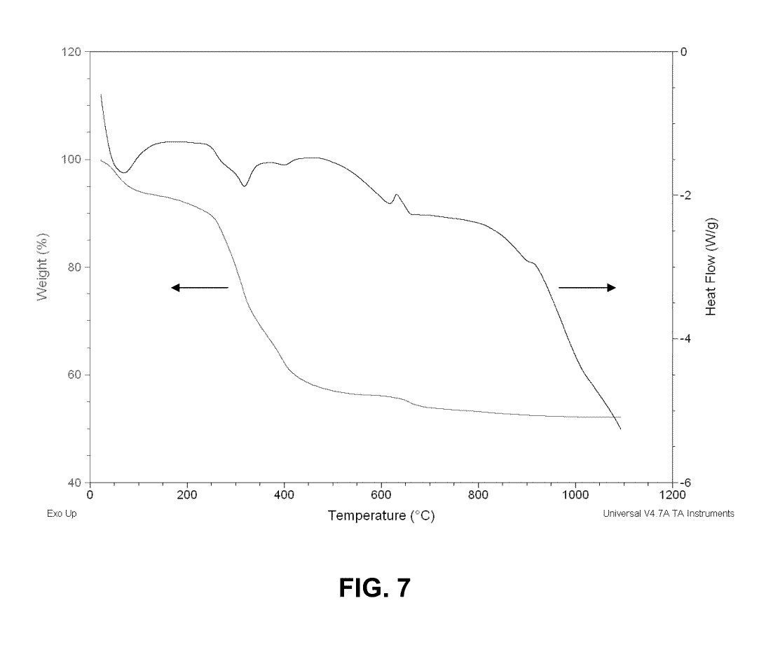

The sol-gel and electrospinning method was used in conjunction with post-spinning thermal treatment to create highly crystalline ferroelectric BaTiO₃ nanofibers. As-spun BaTiO₃ nanofibers exist as a solid membrane, with a smooth surface on individual fibers, as shown in FIGS. 6(a) and 6(b). Thermogravimetric analysis (TGA) was used to determine the mass loss due to solvent removal, organics decomposition, and the onset of crystallization during the thermal treatment of BaTiO₃ nanofiber materials, as shown in FIG. 7. The BaTiO₃ nanofiber structures were further examined by field-emission scanning electron microscopy (SEM), X-ray diffraction (XRD), Energy dispersive X-ray (EDX), high-resolution transmission electron microscopy (TEM), and Raman microscopy for morphology, microstructures, crystallography, and composition characterizations, as described below.

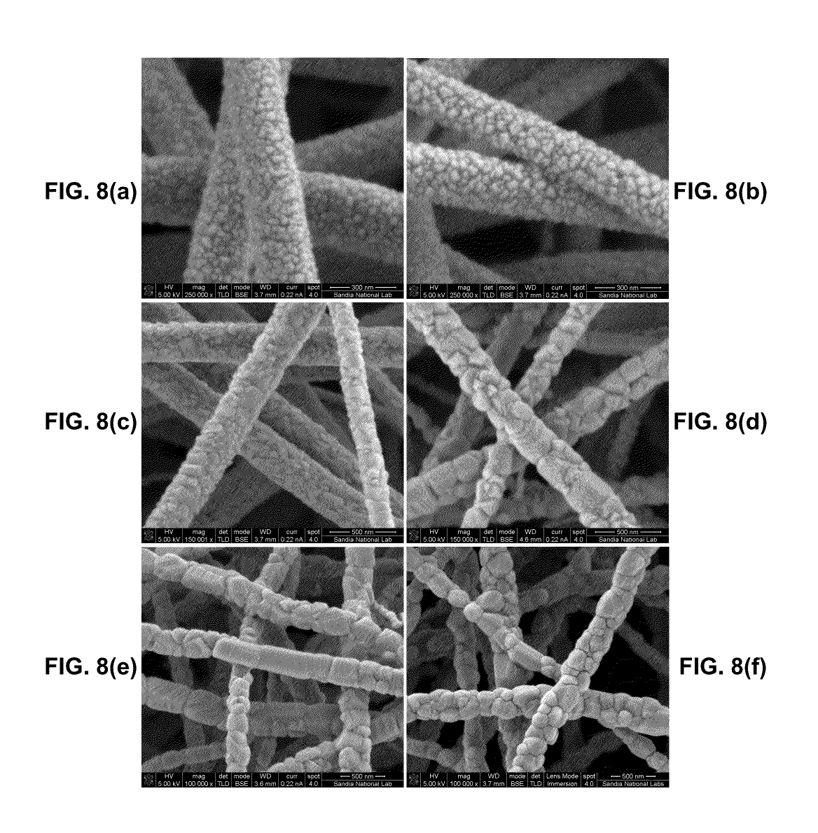

Evolving nanocrystal structures of BaTiO₃ at an alkoxide-carboxylate precursor concentration of 0.5 M under different thermal treatment temperatures at 600° C., 750° C., 850° C., 950° C., and 1100° C. for 10 and 12 hrs, respectively, are shown in FIGS. 8(a)-(f). When starting from sol-gel precursors, the first thing that forms is an amorphous gel. At some point during the heating process, crystalline nuclei form. These can be homogeneous or heterogeneous, depending upon several factors. In a BaTiO₃ sol-gel, the stability of the BaCO₃ phase that always forms tends to delay nucleation until fairly high temperatures, at which point nucleation happens rapidly and broadly. Therefore, at the beginning a large number of very small grains form. The small grains have a large amount of surface, which is a high energy state. In order to reduce this amount of surface energy, the grains will grow if given enough thermal energy for diffusion to occur. The larger grains grow at the expense of the smaller grains, essentially consuming them in the process, a phenomenon called Ostwald ripening. Small grains are also single crystals, just like the large ones. They're also likely more disordered (more crystallographic defects) than the large ones, because they haven't had enough thermal energy to anneal out defects. Eventually the crystallographic facets are all annealed out to form the lowest and most stable energy state. After heat treatment, the cross section of the BaTiO₃ fibers are generally rectangular or circular with diameters in the range of 200˜500 nm (the thinnest less than 50 nm). The BaTiO₃ fibers consist of strings of individual single crystals, and each crystal is considered one grain.

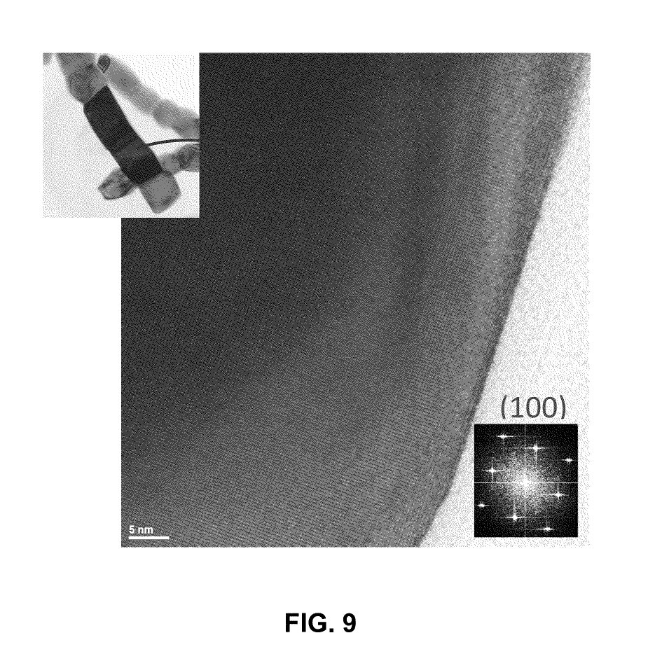

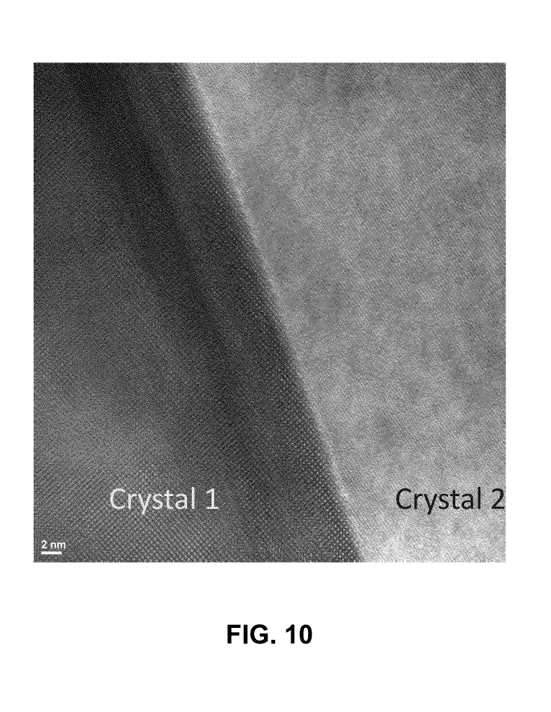

High resolution transmission electron microscopy (HR-TEM) and electron diffraction analysis indicate that the BaTiO₃ fiber is of high purity and high crystallinity, as shown in FIG. 9. HR-TEM imaging of adjacent crystals also indicates the expected nature of the random orientation of the crystals within the nanofiber. As shown in FIG. 10, the left-most crystal 1 was imaged on zone axes so that the lattice fringes are clearly seen, while right-most crystal 2 is not positioned on the same zone axes so that only lateral fringes are seen.

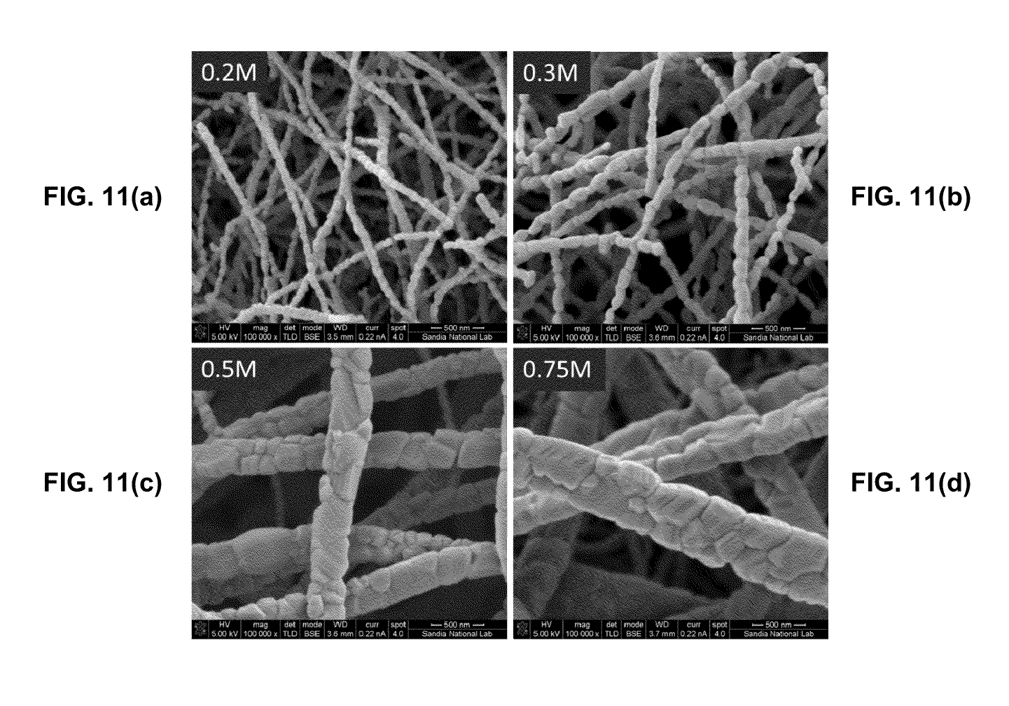

Alkoxide-carboxylate precursor concentrations impact the BaTiO₃ nanofiber grain and domain structures. At lower precursor concentrations, there are fewer nucleation sites, slower diffusion, and less accessible materials, therefore forming thinner fibers with small nanocrystals lining up in a string (single grain per cross section). At higher precursor concentrations, there are more nucleation sites, faster diffusion, and more accessible material, therefore forming thicker fibers with bigger nanocrystals bundled together (several grains per cross section). The structure and morphology of the BaTiO₃ fibers is mostly controlled by the precursor concentrations, shown in FIGS. 11(a)-(d). Flow rates, electric field, and humidity have lesser impacts.

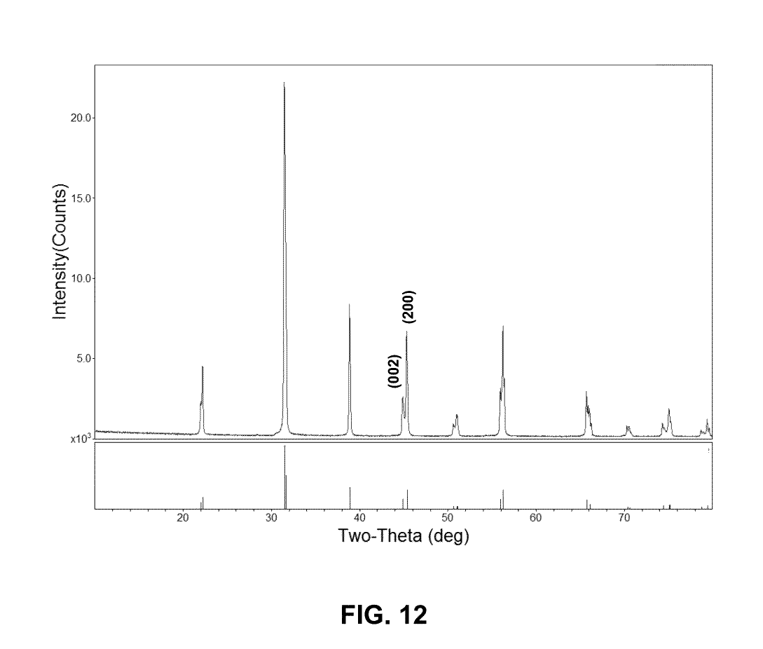

X-ray diffraction (XRD) results indicate outstanding crystallinity of the BaTiO₃ nanofiber materials fabricated via the electrospinning and sol-gel synthesis method. The diffraction peaks can be indexed by a tetragonal crystal structure, specifically evidenced by split of the (200) peak and the (002) peak around 45°, and the integrated diffraction intensity of the (200) peak is nearly twice the value of the integrated diffraction intensity of the (002) peak. A representative XRD is shown in FIG. 12. XRD refinement results suggest that the tetragonal phase is dominating in the obtained perovskite BaTiO₃ nanofiber material.

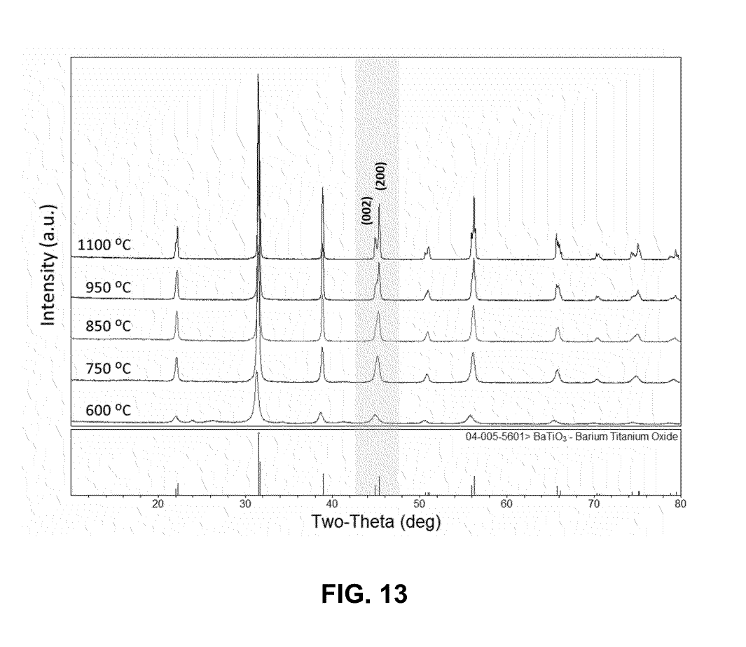

XRD results also suggest that the degree of crystallinity is controlled by the calcination temperature and time. Crystallinity increases with the increase of crystallization temperatures and, most importantly, the tetragonal phase is enriched with higher calcination temperature, as shown in FIG. 13.

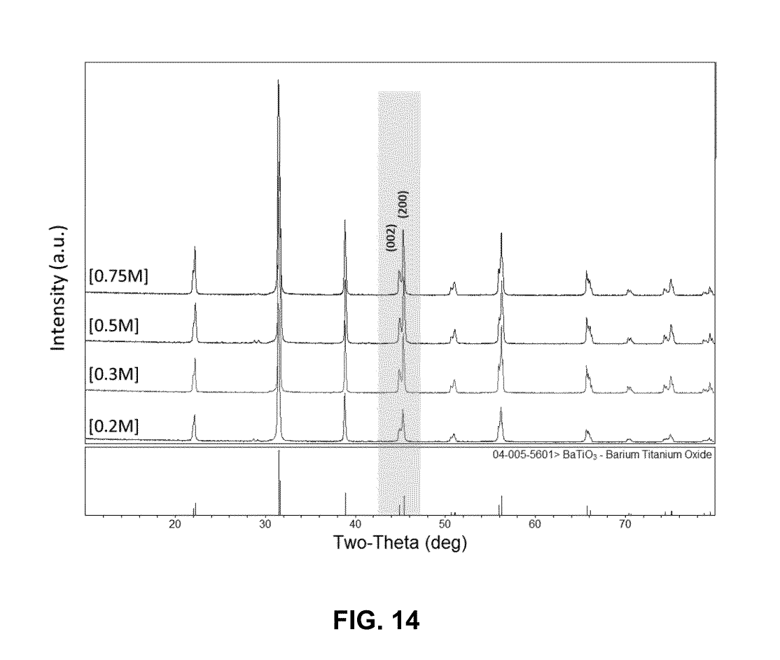

XRD analysis on the BaTiO₃ nanofibers with different precursor concentrations undergoing the same thermal treatment suggests crystallinity gets higher as the crystallization precursor concentration increases, as shown in FIG. 14. As shown in Table 1, the higher the precursor concentration, the higher percentage of tetragonal phase in the final products.

TABLE 1
Relationship between precursor concentration and the tetragonal phase.

| Precursor concentration | Tetragonal phase (wt %) |
|---|---|
| 0.2M (1100° C., 10 h) | 75% |
| 0.3M (1100° C., 10 h) | 90% |
| 0.5M (1100° C., 10 h) | 100% |

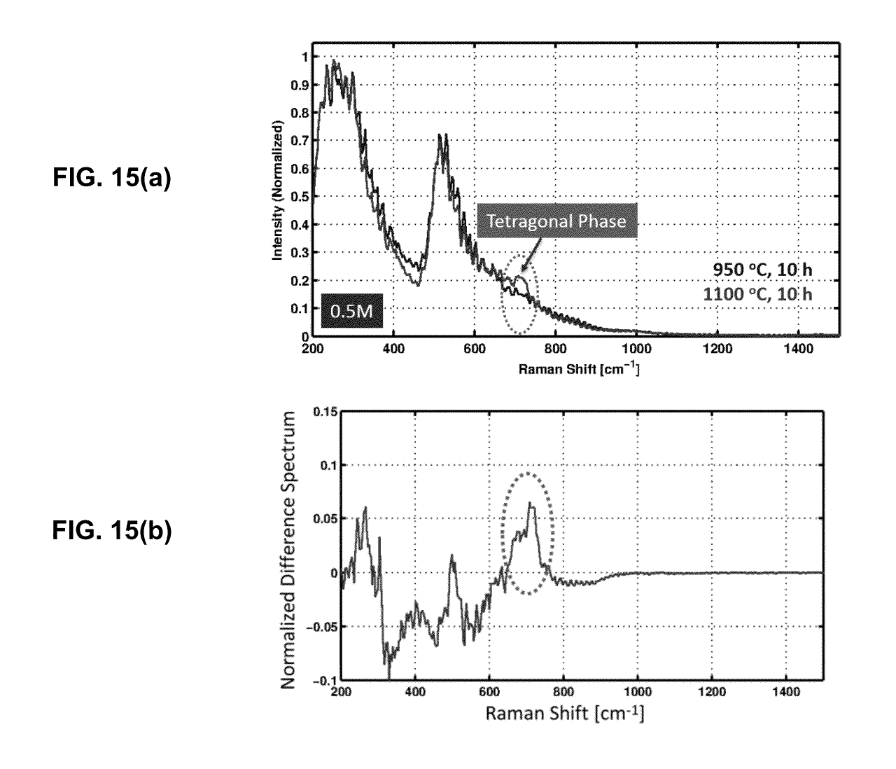

Raman spectroscopy agrees with XRD for the tetragonal phase appearing in BaTiO₃ nanofiber materials. A representative measurement was taken on BaTiO₃ nanofibers from 0.5 M precursor concentrations. Raman imaging was performed using 532 nm light, cross-polarization. The narrow Raman peaks at 720 cm⁻¹ in FIG. 15(a) are specific to the tetragonal phase of BaTiO₃. FIG. 15(b) shows the normalized difference spectrum, further indicating the presence of the tetragonal phase of BaTiO₃ at higher calcination temperature.

### Piezoresponse Characterization

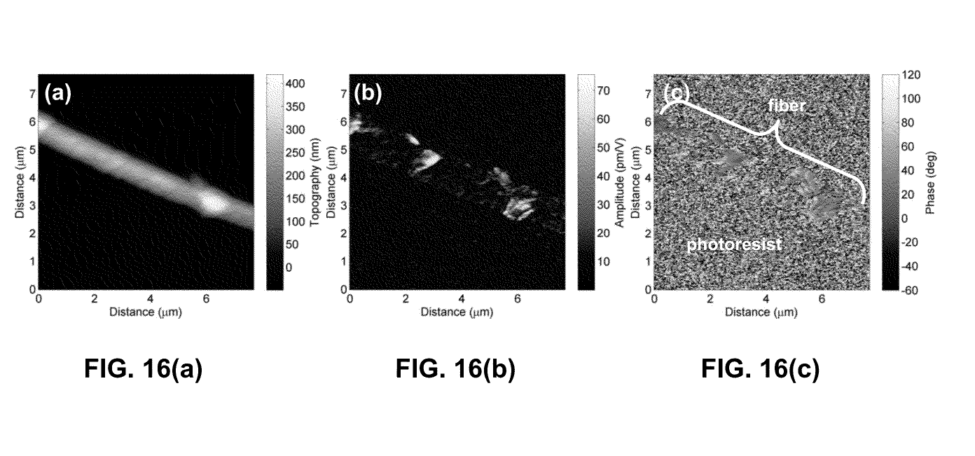

A sample piezoelectric image of an embedded fiber is shown in FIG. 16(a). The fiber is approximately 8 μm long and does not show any breaks or discontinuities. The piezoelectric amplitude image in FIG. 16(b) shows several dark and bright spots along the fiber. This reflects the random crystal orientation in the fibers as well as the arbitrary domain patterns within the crystal regions. Several regions show strong piezoelectric response of ˜70 μm/V. The darker areas show low piezoelectric response, which only indicates that the piezoelectric response is not out of plane in those regions. The piezoelectric phase image in FIG. 16(c) shows random phase in regions of photoresist (as expected since photoresist is non-piezoelectric) and only shows measurable phase in the region of the fiber, clearly indicating that the fiber is indeed piezoelectric. The variation in piezoelectric response indicates the arbitrary nature of the out-of-plane response.

These BaTiO₃ fibers are clearly ferroelectric since XRD data and refinement calculations confirm a tetragonal crystalline phase, and the tetragonal phase of BaTiO₃ is known to be ferroelectric. Further, the piezoelectric response measured in PFM confirms the material is piezoelectric, which in combination with the XRD data further indicates ferroelectricity of this BaTiO₃ nanofiber material.

### Piezochemical Reactions in Solutions

An ultrasonifier instrument, with fixed frequency of 20 kHz and tunable power up to 400 Watts, was used to drive the piezochemical reactions in solution. Ultrasound energy is a type of mechanical energy characterized by vibrating or moving particles within a medium. Ultrasound propagates through compressible media (water in this example) as longitudinal waves, and creates vibrations in the surrounding medium. As the source continues to vibrate the medium, the vibrations propagate away from the source at the speed of sound, thus forming a sound wave. Ultrasound energy requires matter or a medium with particles to vibrate to conduct or propagate its energy. In this example, mechanical energy in the form of ultrasound was transferred to the nanofibers with minimum loss due to the liquid-to-liquid index match at the interface. However, other methods of applying transient mechanical stress to the nanofibers can also be used, such as shaking or other forms of vibrational loading.

At the experimental condition of ultrasonic energy of 250 W at a frequency of 20 kHz for 1 hour, an obvious yellow color appeared in the BaTiO₃ samples. The yellow color change is a direct indication of nano silver particle formation. See Y.-C. Lu and K.-S. Chou, Journal of Chinese Institute of Chemical Engineers 39(6), 673 (2008). With TiO₂ nanofiber as a control, which is a wide bandgap semiconductor known for photochemical reactions, but not a piezoelectric material, there is no obvious color change. This control experiment eliminated photochemistry crosstalk in this experiment condition.

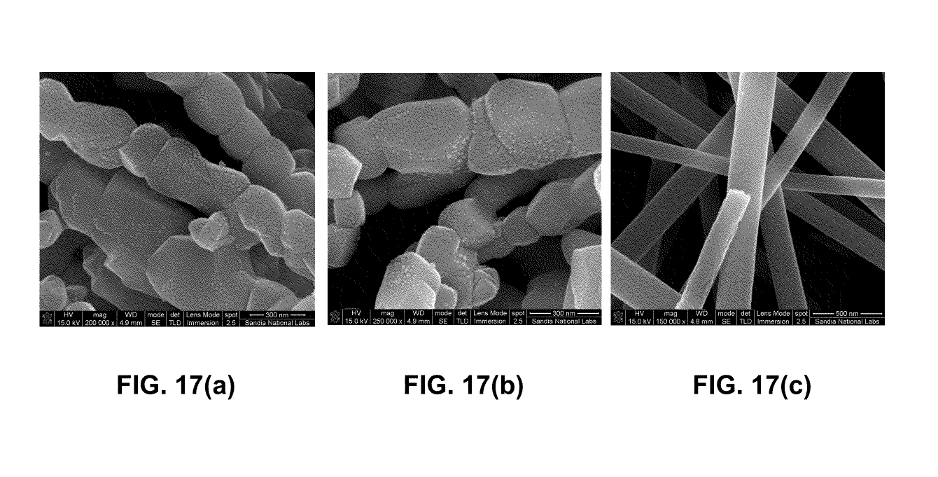

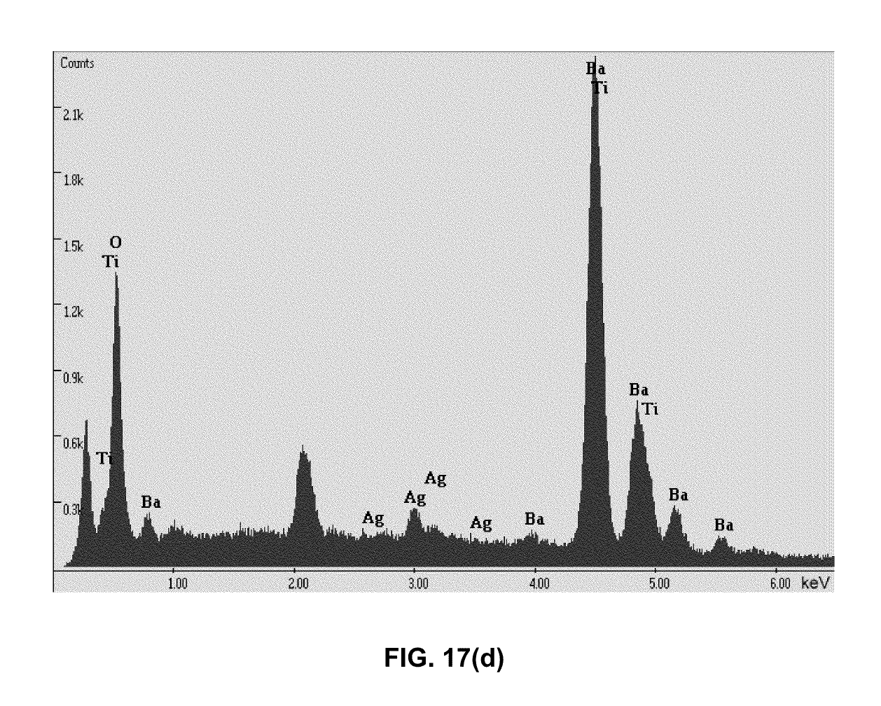

After-reaction BaTiO₃ nanofibers were examined using SEM, as shown in FIGS. 17(a)-(c). Ag nanoparticles were found to selectively deposit on the BaTiO₃ crystal surface in certain patterns, which is most likely related to the grain orientations and predefined domains on the BaTiO₃ nanofibers. The Ag deposition pattern was very similar to the piezoresponse pattern characterized by PFM which was described earlier. Due to the arbitrary nature of crystal orientations within the fiber, as well as the arbitrary domain patterns within the crystal regions, some domains show stronger piezoresponse under mechanical agitation; therefore they become “hot spots” for redox reaction sites. The Ag element was confirmed by EDX analysis, as shown in FIG. 17(d).

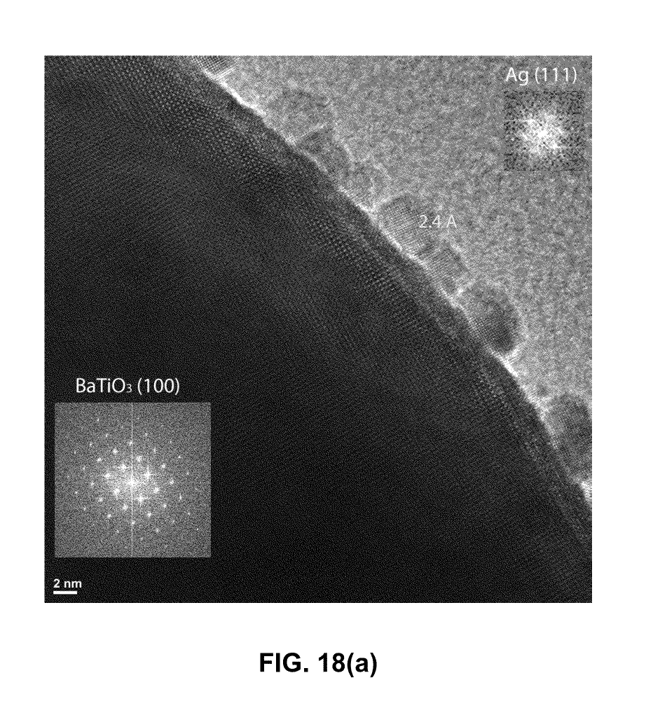

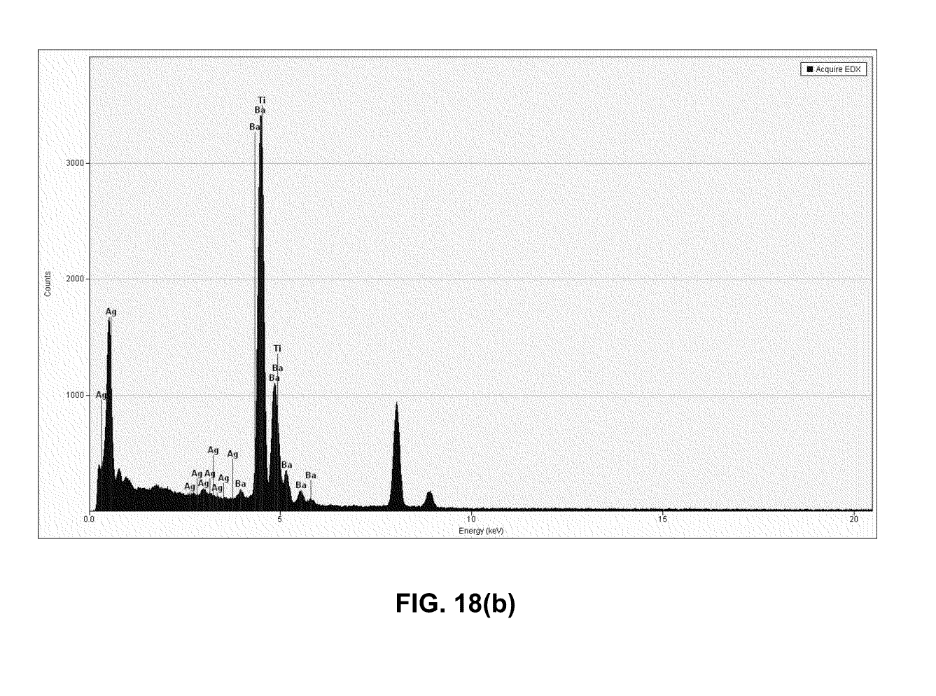

The lattice structures of the BaTiO₃ as well as the Ag particle were examined using HR-TEM, as shown in FIGS. 18(a) and 18(b). The insets are the FFT of the areas of the BaTiO₃ nanocrystal and the Ag nanoparticle, which identifies (100) plane of BaTiO₃ and (111) plane of Ag. A d-spacing of 2.4 Å was also measured and identified the (111) plane of Ag. The Ag particles however showed no evident effect on the XRD patterns, similar to observations reported in literature. See L. Wen et al., Journal of Wuhan University of Technology-Mater. Sci. Ed. 24(2), 258 (2009).

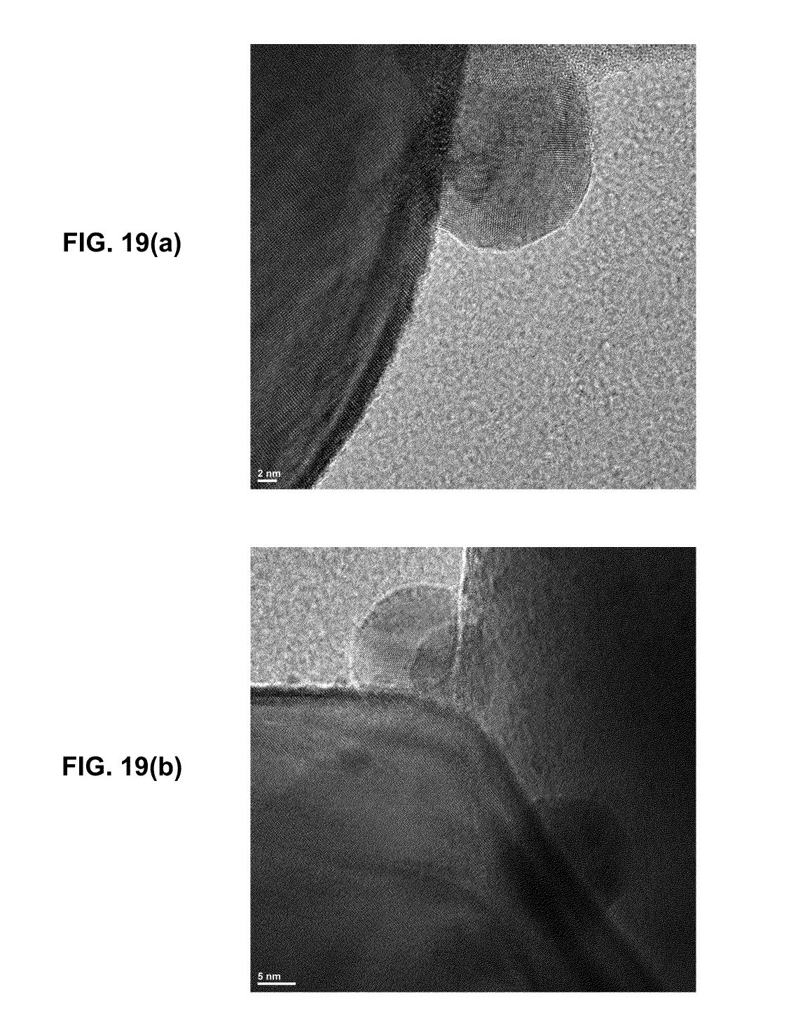

Some regions have relatively large Ag particles, and they are more often observed at the grain boundaries, as shown in FIGS. 19(a) and 19(b). This suggests a greater growth happening in these regions as a result of Ostwald ripening. The possible explanation could be that (1) surface defects promote the nucleation of the metal; and/or (2) surface morphology at the grain boundaries causes large discontinuities of local electric field, which can more effectively disrupt the screening charges therefore providing more effective local electrostatic potential to reduce the Ag metal particles.

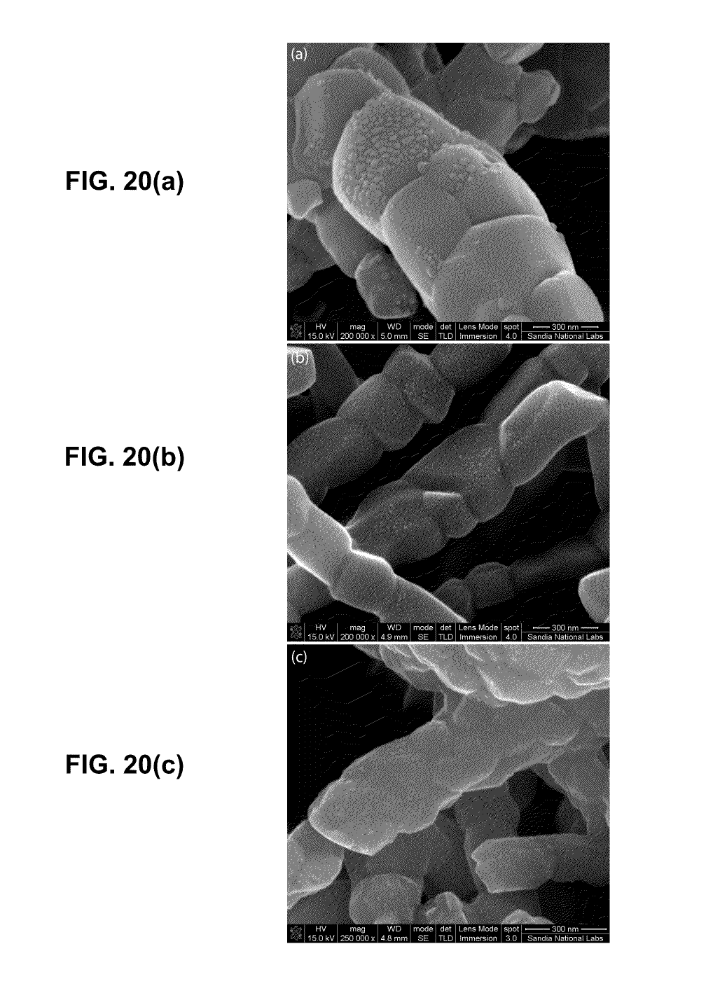

The corresponding silver ion concentrations of AgNO₃ of 0.01 M, 0.05 M, and 0.5 M showed a marked difference on the size and distribution of Ag particle deposition on BaTiO₃ nanofibers, as shown in FIGS. 20(a)-(c).

The after-reaction products have obvious color differences: white, yellow, brown, for 0.5 M, 0.05 M, and 0.01 M initial AgNO₃, respectively. 1 M HNO₃ was used to dissolve the Ag particle to reconstitute the AgNO₃ in solution, which also showed an obvious color difference. The reconstituted AgNO₃ concentration was measured electrochemically using a reference electrode that does not contain chloride ions, with 5000 μM corresponding to initial 0.01 M AgNO₃, 750 μM corresponding to initial 0.05 M AgNO₃, and ˜0 μM corresponding to initial 0.05 M AgNO₃. The increase in the deposition of the silver with lower concentrations of silver nitrate solution is attributed to a lower required energy for the redox reaction. This can be explained by the Gibbs free energy for any chemical reactions. The involved redox reactions are:

Ag⁺+e→Ag E⁰=0.799 V (1)

2H₂O+4h⁺→O₂+4H⁺ E⁰=1.23 V (2)

Therefore the Gibbs energy of the reaction is:

$$Δ E = ( {E}_{Ag}^{0} - {E}_{O 2}^{0} ) + \frac{RT}{nF} lg \frac{{{{[ {H}^{+} ]}^{4} [ {O}_{2} ]}^{P} [ Ag ]}^{4}}{{[ {Ag}^{+} ]}^{4}} = ( 0.799 - 1.23 ) + 0.06 lg \frac{[ {H}^{+} ]}{[ {Ag}^{+} ]} = - 0.431 + 0.06 ( lg [ {H}^{+} ] - lg [ {Ag}^{+} ] ) \qquad ( 3 )$$

From the equation (3), before the mass transfer limit is reached, a lower reactant concentration effectively decreases the energy required to activate the chemical reaction. Therefore, the reaction goes more effectively and yields more products with lower reactant concentration. This supports the proposition that a piezoelectric-effect-induced event involves redox chemical reactions with effective charge transfer.

As a positive control experiment, the BaTiO₃ nanofibers were used to photochemically reduce Ag from aqueous silver cations due to the known photochemical catalysis properties of BaTiO₃ when exposed to UV light. When the absorbed photon energy is greater than the band gap, photo-excited electron-hole pairs are created, and move to the opposite domain surface to reduce the silver cations to elemental Ag. The influence of the ferroelectric domain structures is known to be very significant such that the silver only selectively deposits on certain domain regions. See J. L. Giocondi and G. S. Rohrer, Chemistry of Materials 13(2), 241 (2001). This method is used as a local indicator of surface photochemical reactions, and provides a positive control regarding where the domain structures are likely related to chemical reactions. As expected, the photochemically deposited Ag particles were located in certain domain regions. As a negative control experiment, the BaTiO₃ nanofibers were immersed in boiling AgNO₃ solutions. Thermal decomposition caused Ag particles to deposit on BaTiO₃ surface everywhere, without any domain preference.

Both positive and negative control experiments indicate that the piezoelectric-effect-induced Ag reduction on BaTiO₃ surface is directly linked with specific domain structures, as a logical analogy to the photochemical reactions. The most likely explanation is that the piezoelectric potential in response to external mechanical excitation causes a transient imbalance between induced polarization potential and screening charges. At this transient moment, the induced polarization has not been fully compensated yet by the screening charges, therefore an instantaneous electrostatic potential developed. If this instantaneous electrostatic potential is large enough, it can provide the energy to initiate the electrochemical reactions on the ferroelectric surfaces. Due to the arbitrary nature of the crystal orientation within the nanofibers as well as the arbitrary domain patterns in the nanocrystals, when receiving randomly oriented mechanical agitation by ultrasonic energy in water, certain domain regions present stronger piezoresponse, therefore a more significant transient electrostatic potential is developed to enable local electrochemical reactions that involve charge transfer. Therefore a piezochemical reaction can be also domain specific. This leads to heterogeneous piezochemical reactions on ferroelectric surfaces as long as sufficient mechanical energy is supplied.

The present invention has been described as piezoelectric-effect-induced heterogeneous electrochemical reactions. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method of preparing a piezoelectric nanofiber, comprising:
providing one or more piezoelectric material precursors and a matrix polymer in a solution; and
electrospinning the solution to provide a sol-gel nanofiber of the piezoelectric material.

2. The method of claim 1, wherein the piezoelectric material comprises a perovskite ferroelectric.

3. The method of claim 2, wherein the perovskite ferroelectric comprises Pb(Zr,Ti)O₃, PbTiO₃, or (Ba,Sr)TiO₃.

4. The method of claim 1, wherein the piezoelectric material comprises barium titanate and the one or more piezoelectric material precursors comprise titanium isopropoxide and barium acetate.

5. The method of claim 1, wherein the solution comprises an aqueous solution and the matrix polymer comprises a water-soluble polymer.

6. The method of claim 5, wherein the water-soluble polymer comprises polyvinylpyrrolidone, polyethylene oxide, or polyvinyl alcohol.

7. The method of claim 1, further comprising heating the sol-gel nanofiber to a temperature sufficient to remove solvent and allow hydrolysis and condensation of the sol-gel to complete.

8. The method of claim 7, further comprising heating the nanofiber to a temperature sufficient to burn off the polymer matrix.

9. The method of claim 8, further comprising heating the nanofiber to a temperature sufficient to crystallize the ferroelectric material.

10. A method of inducing a heterogeneous electrochemical reaction, comprising:
providing a redox solution;
immersing a piezoelectric material into the redox solution; and
applying a transient mechanical stress to the piezoelectric material, wherein the ferroelectric domain structure of the piezoelectric material produces a redox chemical reaction on the immersed surface of the piezoelectric material.

11. The method of claim 10, wherein the applying the transient mechanical stress comprises applying a transient acoustic stress.

12. The method of claim 11, wherein the transient acoustic stress comprises ultrasound, infrasound, or vibration.

13. The method of claim 10, wherein the piezoelectric material comprises a perovskite ferroelectric.

14. The method of claim 13, wherein the perovskite ferroelectric comprises barium titanate, Pb(Zr,Ti)O₃, PbTiO₃, or (Ba,Sr)TiO₃.

15. The method of claim 10, wherein the piezoelectric material comprises a micro/nanostructure.

16. The method of claim 15, wherein the micro/nanostructure comprises a nanofiber.

17. The method of claim 15, wherein the micro/nanostructure comprises a nanoparticle, nanorod, nanowire, or nanosheet.

18. The method of claim 10, wherein the redox solution comprises an aqueous silver nitrate solution.
